(19) United States
(12) Patent Application Publication
(10) Pub. No.: US 2026/0201147 A1
(43) Pub. Date: Jul. 16, 2026

(54) RUBBER COMPOSITION WITH LONGER LASTING ANTIOZONATION SYSTEM

(71) Applicants: Shaw Xiaofeng YANG, Greenville, SC (US); Jesse J ARNOLD, Greenville, SC (US); COMPAGNIE GENERALE DES ETABLISSEMENTS MICHELIN, Clermont-Ferrand (FR)

(72) Inventors: Xiaofeng Shaw YANG, Simpsonville, SC (US); Jesse J. ARNOLD, Simpsonville, SC (US); Anne-Frédérique SALIT, Riom (FR)

(21) Appl. No.: 19/137,434

(22) PCT Filed: Dec. 13, 2023
(86) PCT No.: PCT/US23/83729

§ 371 Date: Jun. 10, 2025

Related U.S. Application Data
(60) Provisional application No. 63/432,359, filed on Dec. 13, 2022.

(51) Int. Cl. C08K 5/29; B60C 1/00; C08K 5/18; C08L 7/00

(52) U.S. Cl. CPC C08K 5/29; B60C 1/0016; B60C 1/0025; C08K 5/18; C08L 7/00; C08L 2201/08; C08L 2205/06; C08L 2312/00

(57) ABSTRACT

A rubber composition having improved antiozonation performance comprising an antiozonation systems comprising an antiozonant and a linking agent. Such a composition is particularly suitable for rubber articles. The improved rubber composition possesses a long lasting antiozonation performance, slowing migration through the rubber article and reducing effluence of the antiozonant. Such rubber articles may include rubber pneumatic tires, solid tires, non-pneumatic tires, belts, hoses, cables, automotive mounts, bushings and general mechanic products that are exposed to continuous and intermittent dynamic operation conditions and require protection from ozonation.

### FIELD OF THE INVENTION

This invention relates generally to rubber compositions and more particularly, to tire rubber compositions having improved antiozonation performance and particularly having good antiozonation performance without the need for use of 6PPD. Such a composition is particularly suitable for rubber articles. Such rubber articles may include rubber pneumatic tires, solid tires, non-pneumatic tires, belts, hoses, cables, automotive mounts, bushings and general mechanic products that are exposed to continuous and intermittent dynamic operation conditions and require protection from ozonation.

### BACKGROUND OF THE INVENTION

Tires and other articles that are made of rubber are manufactured from rubber compositions that include rubber, e.g., natural rubber, synthetic rubber or combinations thereof, reinforcing fillers, vulcanizing agents, and other components that improve the physical mechanical characteristics of both the uncured and the cured rubber compositions.

It is well known that if unprotected, ozone in the environment will attack the surface of rubber which is generally formulated with highly unsaturated elastomers, particularly if the rubber is under strain during usage. This ozone attack will result in small cracks on the surface of the rubber, which could develop into deep and large cracks. The small cracks diminish the cosmetic aesthetics while deep and large cracks may shorten the service life of the rubber articles such as tires.

To combat ozone attack, various antiozonants have been developed and commercialized to slow down the formation of the ozone cracks under static and dynamic conditions. For example, waxes of various characteristics have been developed and used in rubbers against static ozone attack by forming a film barrier on the surface, though such film will break and lose ozone protection under dynamic conditions. For dynamic protection, various chemical antiozonants are developed and commercially available, with one of the well-known and widely used groups being the substituted phenyl-p-phenylenediamines, or PPDs. These PPDs may include N-isopropyl-N′-phenyl-p-phenylene (IPPD), N-1,3-dimethylbutyl-N′-phenyl-p-phenylendiamine (6PPD), N,N′-bis-(1,4-dimethylpentyl)-p-phenylenediamine (77PD), N-cyclohexyl-N′-phenyl-p-phenylenediamine (CHPPD), and N,N′-diphenyl-p-phenylenediamine (DPPD). Though still not well understood, it is generally accepted that it is the amino groups on the PPD molecules that protect rubbers by reacting with ozone molecules and thus reducing the ozone concentration at the surface of the rubber articles. Notice that these PPDs can also act as a primary and a secondary antioxidant by scavenging free radicals and converting hydroperoxides into less harmful intermediates.

During the service life of said rubber compositions, the antiozonant has to migrate to the surface in order to react with and provide protection against ozone in the environment, such as in the case of tire sidewalls and treads. The migration rate dictates the service life of the rubber articles; the faster the migration to the surface, the better the initial protection. However, at a fixed loading of the antiozonant, too fast a migration to the surface will not only negatively impact the long-term protection due to surface leaching and/or volatilization, but also cause “staining” of the article due to excessive surface concentration. Therefore, some longer-lasting antiozonants of larger molecular sizes have been proposed and developed. For example, U.S. Pat. No. 6,444,759 discloses a rubber composition having protective agent as a salt form of p-phenylenediamine and acid; said composition not comprising an elastomeric copolymer having glycidyl groups. U.S. Pat. No. 5,047,530 teaches the preparation and use of a larger molecule, substituted triazine for longer lasting and non-staining ozone protection.

Antiozonant molecules having a migration rate slower than 6PPD such as hydroxylated form of substituted phenyl-p-phenylenediamine (sPPD-OH) and quinoneimine form of substituted (hydroxy)phenylamine (sPAQI) have shown promising alternatives to 6PPD as noted in PCT application publications WO 2022/146,441 and WO 2022/146,442. Though the environmental effects of the products of their degradation are still not fully understood, such molecules show promise. Further improvements to such antiozonants would be desirable.

Another group of chemicals, hindered phenols, for example, 2,2′-methylenebis(4-methyl-6-tert-butylphenol), are often used as an antioxidant in rubber compositions, even though they have no protection against ozone attack. Since these hindered phenols are generally non-staining, they are often compounded in light colored articles where staining should be minimized, such as white sidewalls and colored treads in tires. Though the exact mechanisms are still not well known, it is generally accepted that it is the hydroxyl group that acts as a primary antioxidant by donating a hydrogen atom to a radical, scavenging the radical generated during oxidation or aging.

Yet another group of chemicals selected from quinone (Q), quinoneimine (QI), and quinonedimine (QDI) have been reported in rubber formulations. For example, U.S. Pat. No. 6,533,859 discloses a method to pretreat carbon black surface with such chemicals to improve the dispersibility of the carbon black and the dynamic properties of the rubber formulations. EP1,025,155 teaches a process to improve the processability of uncured rubber through high temperature mixing of quinonedimine, natural rubber, and carbon black. U.S. Pat. No. 8,207,247 teaches a process to mix a rubber composition comprising natural rubber and an additive selected from aforementioned chemicals, preferably a quinonedimine.

Yet, another group of chemicals, a hydroxyl phenyl-phenylamine combined with a methylene donor, was reported to improve rubber's antiozonation and/or antifatigue abilities. For example, U.S. Pat. No. 9,518,165 discloses a tire rubber component and a method for the same, comprising a diene elastomer, a reinforcing filler, a methylene donor, a methylene acceptor selected from 3-hydroxydiphenylamine, 4-hydroxydiphenylamine and combinations thereof, wherein the ratio of the methylene acceptor to the methylene donor is at least 15:1. U.S. Pat. No. 9,708,459, discloses a tire rubber component comprising a methylene donor and a hydroxy diphenylamine having the following structure,

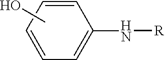

Yet, though not related to rubber formulations, U.S. Pat. No. 10,723,969 discloses the use of alkylated hydroxy-phenyl-phenylamine, reference the structure below, in automobile engine lubricating oil to provide antioxidation and deposit control performance. U.S. Pat. No. 10,723,969 teaches the use of a single amine structure, and does not teach that this engine oil additive would be useful as a tire antidegradant.

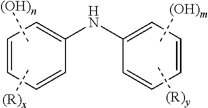

Recent concerns of the possible toxic effects to coho salmon of 6PPD-quinone, a chemical formed from 6PPD interacting with ozone, have been brought forward in a recent study, as state in “A ubiquitous tire rubber-derived chemical induces acute mortality in coho salmon”, Zhenyu Tian et al, Science, 371 (6525), 185-189 (2020). If true, it would be useful to identify a suitable antiozonant that may reduce or eliminate the quantity required of 6PPD to protect rubber products, including tires. Particularly useful would be an antiozonant that does not form 6PPD-quinone as a result of its function in protecting the rubber product from ozone.

Consumers expect durable long-lasting rubber products that remain aesthetically pleasing throughout their service life. A need exists for an improved rubber mix that possesses a longer lasting antiozonant with reduced migration speed.

### SUMMARY OF THE INVENTION

Particular embodiments of the present invention include a rubber composition having a longer lasting antiozonant. Embodiments of the invention may be useful for finished rubber articles including nonpneumatic tires, solid tires pneumatic tires, and tire components. Aspects and advantages of the invention will be set forth in part in the following description, or may be obvious from the description, or may be learned through practice of the invention. Particular embodiments of the present invention include rubber compositions, articles made from such rubber compositions, and the methods for making the same. Such embodiments include a tire component; the tire component comprising a rubber composition that is based upon a cross-linkable elastomer composition; the cross-linkable elastomer composition comprising, per 100 parts by weight of rubber (phr), a highly unsaturated diene elastomer, a reinforcing filler, a vulcanization package, and an antiozonation system comprised of an antiozonant and a reactive linking agent for the antiozonant; wherein the antiozonant is selected from the molecules having structures in (I) and (II), respectively,

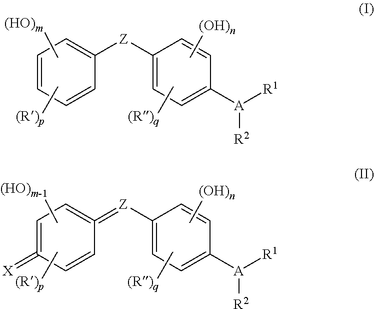

and wherein the linking agent is selected from a methylene donor and an epoxide; wherein the linking agent in the antiozonation system increases the antiozonant size by reacting with the antiozonant molecule at proper conditions such as downstream curing in tire articles.

With reference to the above antiozonant structures (I) and (II), Z is selected from carbon, nitrogen, and sulfur; X is selected from oxygen, carbon, nitrogen, and sulfur; A is selected from nitrogen and sulfur. m is 1 or 2, n is 0, 1, or 2; p is 0, 1, 2, 3, or 4; q is 0, 1, 2, 3, or 4; the summation of m and p is less than 6; the summation of n and q is less than 5. For each structure, each of R′, R″, R¹, and R² can be the same or different, and is selected from hydrogen, an alkyl moiety, a cycloalkyl moiety, an aryl moiety, an amine moiety, an amide moiety, an alcohol moiety, an aldehyde moiety, a ketone moiety, a carboxylic acid moiety, an ether moiety, an ester moiety, and a thiol moiety, or combinations thereof.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides schematic view of a “composite” ozone test specimen to determine the migration of the antiozonant.

The use of identical or similar reference numerals in different figures denotes identical or similar features.

### DETAILED DESCRIPTION OF THE INVENTION

The present invention pertains to a rubber having a longer lasting antiozonation system. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

Methods that are embodiments of the present invention include methods for manufacturing a tire component, such methods comprising mixing together components of a rubber composition into a non-productive mix, the components including a highly unsaturated diene elastomer, a reinforcing filler, and an antiozonant selected from structures in (I) and (II). Such methods may further include cooling the non-productive mix and mixing a vulcanizing package and a linking agent for the antiozonant into the non-productive mix to convert the non-productive mix to a productive mix. Alternatively, the aforementioned antiozonant can be added at the same time as the vulcanizing package into the non-productive mix to form the productive mix. In particular embodiments, the method may further include forming the tire component from the productive mix.

It was surprisingly found that compared to the widely used 6PPD, dPPD-OH, denoted for 4-{[4-(dimethylamino)phenyl]amino}phenol, a model molecule for structure (I), and dPAQI, denoted for 4-{[4-(dimethylamino)phenyl]imino}cyclohexa-2,5-dien-1-one, a model molecule for structure (II), when combined with hexamethylenetetramine, provided not only comparable initial antiozonation performances, but also significantly improved longevity for antiozonation performances in a rubber formulation.

Provided is a rubber composition comprising, a rubber, a reinforcing filler, a vulcanization system, and an antiozonation system that is comprised of an antiozonant and a linking agent for the antiozonant; wherein the antiozonant is selected from the molecules having structures in (I) and (II), respectively,

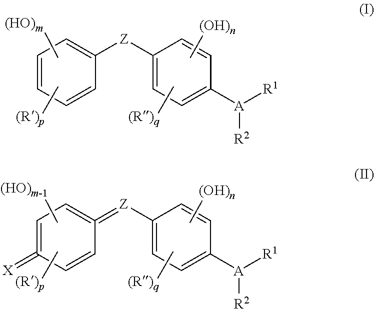

and wherein the linking agent is selected from a methylene donor and an epoxide. The linking agent in the antiozonation system enlarges the antiozonant size by reacting with the antiozonant molecule at proper conditions such as downstream curing in tire articles. Linking agents that are suitable include epoxides and methylene donors.

In the antiozonant structures (I) and (II), Z is selected from carbon, nitrogen, and sulfur. X is selected from oxygen, carbon, nitrogen, and sulfur. A is selected from nitrogen and sulfur. m is 1 or 2, n is 0, 1, or 2; typically m is 1 and n is 0 or 1, and in many embodiments, m is 1 and n is 0. Furthermore p is 0, 1, 2, 3, or 4; q is 0, 1, 2, 3, or 4; typically p is 0 or 1 and q is 0 or 1, and in many embodiments, both p and q are 0. The summation of m and p is less than 6; the summation of n and q is less than 5. For either structure, each of R′, R″, R¹, and R² can be the same or different, and is selected from hydrogen, an alkyl moiety, a cycloalkyl moiety, an aryl moiety, an amine moiety, an amide moiety, an alcohol moiety, an aldehyde moiety, a ketone moiety, a carboxylic acid moiety, an ether moiety, an ester moiety, and a thiol moiety, or combinations thereof. Typically, each of R′, R″, R¹, and R² is selected from hydrogen, an alkyl moiety, a cycloalkyl moiety, and an aryl moiety, or combinations thereof.

In many embodiments, the combinations of the values of m, n, p, q, the forms of X, Z, A, R¹ and R², the forms and the locations of R′ and R″, and the types of the linking agents will result in different antiozonation systems with various antiozonation performances and longevities.

In particular, m is 1 or 2; in many embodiments m is 1. When m is 1, there will be one hydroxyl group on the phenyl ring in (I) but not any hydroxyl group in (II) on the 6-membered ring in (II); and the hydroxyl group in (I) can be located at any position on the phenyl ring available for substitution, preferably on the para position relative to the Z group. When m is 2, there will be two hydroxyl groups on the phenyl ring in (I) and one hydroxyl group on the 6-membered ring in (II), and the hydroxyl groups can be located at any position available for substitution; preferably one of the two hydroxyl groups in (I) be on the para position relative to the Z group on the phenyl ring, and the hydroxyl group in (II) be adjacent to the double bounded Z on the 6-membered ring.

For the structures (I) and (II) discussed, n is 0, 1 or 2; in many embodiments n is 0 or 1. When n is 0, there will be not any hydroxyl group on the phenyl ring in (I) and (II). When n is 1, there will be only one hydroxyl group on the phenyl ring, and it can be located at any position available for substitution. When n is 2, there will be two hydroxyl groups on the phenyl ring, which can be located at any position available for substitution.

For both structures, p is 0, 1, 2, 3, or 4, as long as the summation of p and m is less than 6. In many embodiments, p is 0, 1 or 2. When p is 0, there will be no R′ substitution.

For the structures discussed, q is 0, 1, 2, 3, or 4, as long as the summation of q and n is less than 5. In many embodiments, q is 0, 1 or 2. When q is 0, there will be no R″ substitution.

In the antiozonant structures (I) and (II), Z is selected from carbon, nitrogen, and sulfur; typically Z is a carbon or a nitrogen. In structure (II), X is selected from oxygen, carbon, nitrogen, and sulfur; typically X is an oxygen, or a nitrogen. In both (I) and (II), A is selected from nitrogen and sulfur; typically A is nitrogen.

The location of each R′ can be at any position on the 6-membered rings; preferably at least one R′ is adjacent to the hydroxyl group in (I) or adjacent to X in (II). The location of R″ can be at any position on the phenyl ring in both (I) and (II).

Each of the R¹, R², R′, and R″ moieties may be characterized for particular embodiments per the following. The alkyl moiety may range, for example, between 1 and 24 carbons or alternatively between any range of the combination of such numbers including, for example, between 1 and 18 carbons, between 1 and 7 carbons, between 3 and 18 carbons, between 4 and 9 carbons, and the alkyl moiety may be straight or branched. The cycloalkyl moiety and the aryl moiety may be formed of between 3 and 7 members making up the ring or alternatively between 3 and 6 members or between 5 and 6 members. The members are typically carbon but in some embodiments, the cycloalkyl and aryl moieties may be heterocyclic so that one of the members making up the ring may be oxygen, nitrogen, sulfur, or combinations thereof, the remaining members being carbon. Each of the other moieties, including amine, amide, alcohol, aldehyde, ketone, carboxylic acid, ether, ester, and thiol, may be characterized by having numbers of carbons ranging between 1 and 24, straight or branched.

Examples of useful antiozonants according to structure (I) include, but are not limited to: 4-{[4-(dimethylamino)phenyl]amino}phenol in (1-1); 4-({4-[(4-methylpentan-2-yl)amino]phenyl}amino) phenol in (I-2); 4-({3-methyl-4-[(4-methylpentan-2-yl)amino]phenyl}amino) phenol in (1-3); 2,6-di-tert-butyl-4-({4-[(4-methylpentan-2-yl)amino]phenyl}amino) phenol in (I-4); 5-[(4-hydroxyphenyl)amino]-2-[(4-methylpentan-2-yl)amino]phenol in (I-5); 4-({4-[(3,5-dinitrothiophen-2-yl)amino]phenyl}amino) phenol in (I-6); 4-{[4-(dimethylamino)phenyl] methyl} phenol in (I-7).

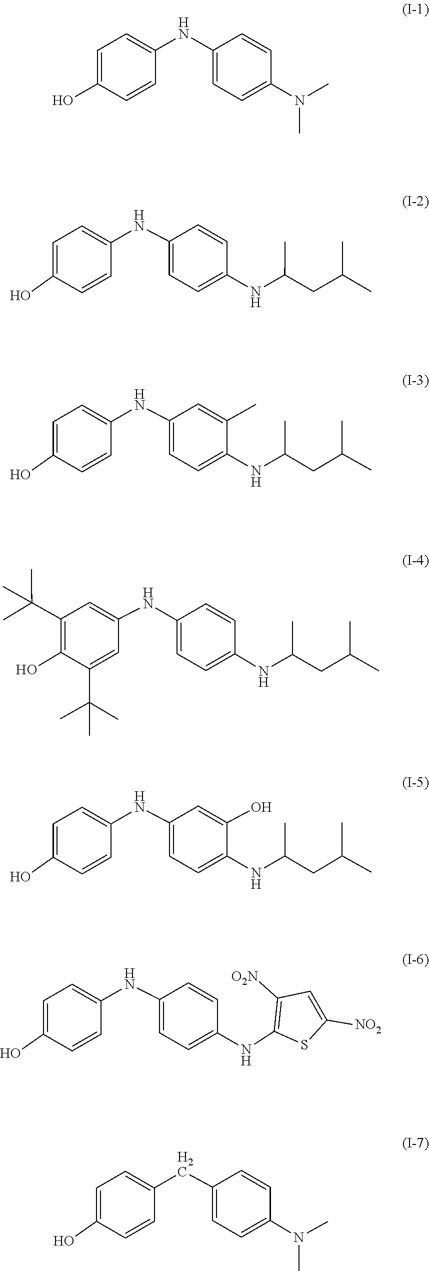

Examples of useful antiozonants according to structure (II) include, but are not limited to: 4-{[4-(dimethylamino)phenyl]imino}cyclohexa-2,5-dien-1-one in (II-1); 4-({4-[(4-methylpentan-2-yl)amino]phenyl} imino) cyclohexa-2,5-dien-1-one in (II-2); 4-({3-methyl-4-[(4-methylpentan-2-yl)amino]phenyl} imino) cyclohexa-2,5-dien-1-one in (II-3); 2,6-di-tert-butyl-4-({3-methyl-4-[(4-methylpentan-2-yl)amino]phenyl} imino) cyclohexa-2,5-dien-1-one in (II-4); 4-({3-hydroxy-4-[(4-methylpentan-2-yl)amino]phenyl} imino) cyclohexa-2,5-dien-1-one in (II-5); 4-({4-[(4-methylpentan-2-yl)amino]phenyl} imino) cyclohexa-2,5-diene-1-thione in (II-6).

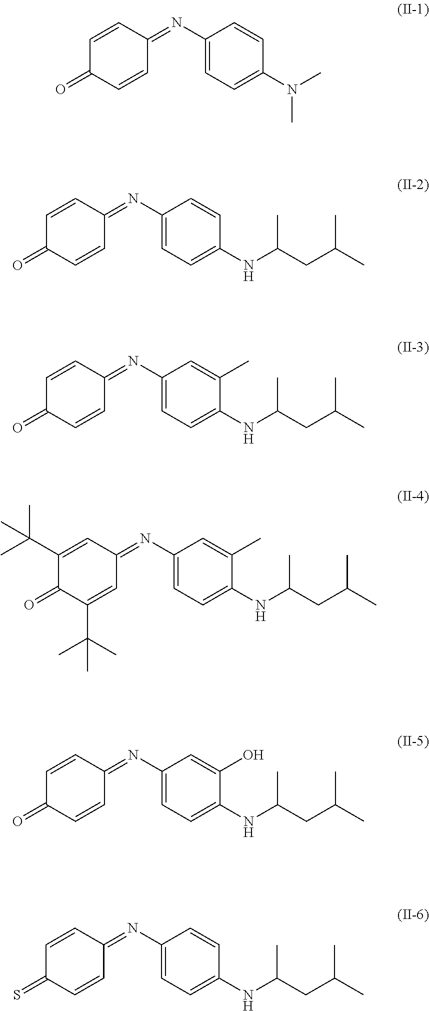

Another aspect of the antiozonation system in this invention includes a linking agent selected from a methylene donor and an epoxide; wherein the linking agent reacts with the antiozonant molecule at proper conditions such as downstream curing in tire articles.

Suitable methylene donors may be selected, for example, from hexamethylenetetramine (HMT); hexamethoxymethylmelamine (HMMM); formaldehyde; paraformaldehyde; trioxane; 2-methyl-2-nitro-1-propanal; substituted melamine resins such as N-substituted oxymethylmelamine resins; glycoluril compounds such as tetramethoxymethyl glycoluril; urea-formaldehyde resins such as butylated urea-formaldehyde resins; or mixtures thereof. Hexamethylenetetramine (HMT), hexamethoxymethylmelamine (HMMM) or mixtures thereof are preferred methylene donors in particular embodiments. Any combination of these methylene donors and other suitable methylene donors may be used in particular embodiments.

Suitable epoxide can be in the form of the following structure in (III),

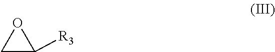

wherein R₃ can be a single or repeating substituents, and is selected from an alkyl moiety, an alkenyl moiety, an aryl moiety, a phenol moiety, a phenolic epoxide moiety, a halogen moiety, a halohydrin moiety, or combinations thereof.

A more useful epoxide is the phenolic epoxide the following structure in (IV),

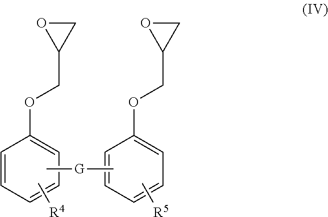

wherein G is selected from an alkyl moiety, an alkenyl moiety, an aryl moiety, a phenol moiety, a phenolic epoxide moiety, or combinations thereof; each of R⁴ and R⁵ can be the same or different, and are selected from a hydrogen, an alkyl moiety, an alkenyl moiety, an aryl moiety, a phenol moiety, a phenolic epoxide moiety, or combinations thereof. Below are some phenolic epoxides that could be useful in rubber compositions such as in tire applications.

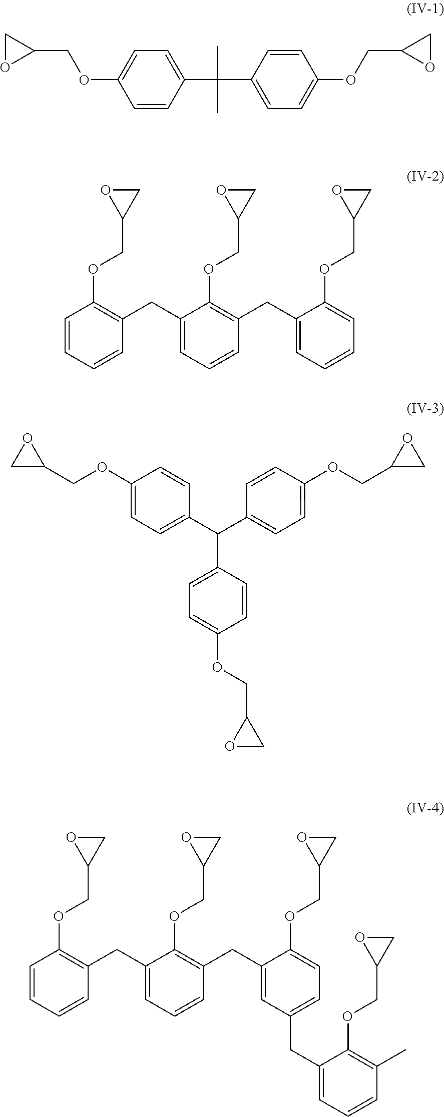 [SMILES: CC(C)(c1ccc(OCC2CO2)cc1)c1ccc(OCC2CO2)cc1 ; c1ccc(OCC2CO2)c(Cc2cccc(Cc3ccccc3OCC3CO3)c2OCC2CO2)c1 ; c1cc(C(c2ccc(OCC3CO3)cc2)c2ccc(OCC3CO3)cc2)ccc1OCC1CO1 ; Cc1cccc(Cc2ccc(OCC3CO3)c(Cc3cccc(Cc4ccccc4OCC4CO4)c3OCC3CO3)c2)c1OCC1CO1]

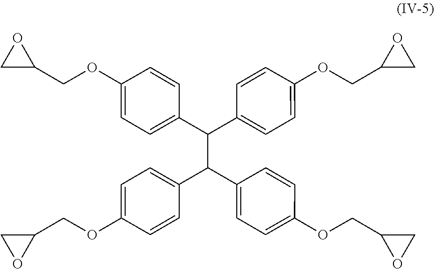 [SMILES: c1cc(C(c2ccc(OCC3CO3)cc2)C(c2ccc(OCC3CO3)cc2)c2ccc(OCC3CO3)cc2)ccc1OCC1CO1]

wherein in (IV-6), k represents the total number of phenolic epoxide groups with k having a range from 3 to 13, and R⁶ can be the same as or different from R⁴ and R⁵, and is selected from a hydrogen, an alkyl moiety, an alkenyl moiety, an aryl moiety, a phenol moiety, a phenolic epoxide moiety, or combinations thereof.

Other examples of the antiozonation systems may include those with different antiozonants and different linking agents with various types of X, Z, A, and G, various values of m, n, p, and q, and specific forms and locations of R¹, R², R³, R₄, R⁵, R⁶, R′, and R″ such that the resultant compounds still possess effective antiozonation in rubber formulations.

The typical loadings of the antiozonants and its linking agent in the antiozonation system may vary as needed for the rubber application, severity of use, environmental and other factors. For the several embodiments disclosed, the loading of the above disclosed antiozonant in structures (I) or (II) is between 0.2 and 15 phr, alternatively between 0.5 and 10 phr, and between 1 and 5 phr; wherein the loading of the antiozonant linking agent is between 0.02 and 15 phr, alternatively between 0.05 and 10 phr, and between 0.1 and 5 phr, respectively.

In the rubber composition comprising the above antiozonation system, other components such as elastomer, filler, plasticizer, and vulcanization will be further described below.

Elastomers: The rubber elastomers suitable for use with particular embodiments of the present invention include highly unsaturated diene elastomers, for example, polybutadiene rubber (BR), polyisoprene rubber (IR), natural rubber (NR), styrene-butadiene rubber (SBR), isobutylene isoprene rubber (IIR) butadiene copolymers, isoprene copolymers and mixtures of these elastomers. The polyisoprenes include synthetic cis-1,4 polyisoprene, which may be characterized as possessing cis-1,4 bonds at more than 90 mol. % or alternatively, at more than 98 mol. %. Particular embodiments of the disclosed rubber compositions include only natural rubber.

Also suitable for use in particular embodiments of the present invention are rubber elastomers that are copolymers and include, for example, butadiene-styrene copolymers (SBR), butadiene-isoprene copolymers (BIR), isoprene-styrene copolymers (SIR) and isoprene-butadiene-styrene copolymers (SBIR) and mixtures thereof.

The elastomer system can be a blend of various elastomers with a total of 100 phr.

Reinforcing fillers: the reinforcing fillers include carbon black, silica (and the associated silane chemistry).

Carbon black, which is an organic filler, is well known to those having ordinary skill in the rubber compounding field. The carbon black included in the rubber compositions produced by the methods disclosed herein may, in particular embodiments for example, be in an amount of between 30 phr and 150 phr or alternatively between 40 phr and 100 phr or between 40 phr and 80 phr. Suitable carbon blacks are any carbon blacks known in the art and suitable for the given purpose for example, any carbon black having a BET surface area or a specific CTAB surface area both of which are less than 400 m2/g or alternatively, between 20 and 200 m2/g may be suitable for particular embodiments based on the desired properties of the cured rubber composition. The CTAB specific surface area is the external surface area determined in accordance with Standard AFNOR-NFT-45007 of November 1987. Suitable carbon blacks of the type HAF, ISAF and SAF, for example, are conventionally used in tire treads. Non-limitative examples of carbon blacks include, for example, the N115, N134, N234, N299, N326, N330, N339, N343, N347, N375 and the 600 series of carbon blacks, including, but not limited to N630, N650 and N660 carbon blacks.

As noted above, silica may also be useful as reinforcement filler. The silica may be any reinforcing silica known to one having ordinary skill in the art including, for example, any precipitated or pyrogenic silica having a BET surface area and a specific CTAB surface area both of which are less than 450 m2/g or alternatively, between 20 and 400 m2/g may be suitable for particular embodiments based on the desired properties of the cured rubber composition. Particular embodiments of rubber compositions disclosed herein may include a silica having a CTAB of between 80 and 200 m2/g, between 100 and 190 m2/g, between 120 and 190 m2/g or between 140 and 180 m2/g.

When silica is added to the rubber composition, a proportional amount of a silane coupling agent is also added to the rubber composition. The silane coupling agent is a sulfur-containing organosilicon compound that reacts with the silanol groups of the silica during mixing and with the elastomers during vulcanization to provide improved properties of the cured rubber composition. A suitable coupling agent is one that is capable of establishing a sufficient chemical and/or physical bond between the inorganic filler and the diene elastomer; which is at least bifunctional, having, for example, the simplified general formula “Y-T-X”, in which: Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica); X represents a functional group (“X” function) which is capable of bonding physically and/or chemically with the diene elastomer, for example by means of a sulfur atom; T represents a divalent organic group making it possible to link Y and X.

Other fillers may also be included as reinforcing fillers to the elastomer system, for example, graphene, graphite, zeolite, and so forth.

Plasticizers: the plasticizers include oils, resins (from petroleum or other natural renewable resources, e.g., sunflower seeds, citrus orange peels). Processing oils are well known to one having ordinary skill in the art, are generally extracted from petroleum and are classified as being paraffinic, aromatic or naphthenic type processing oil, including MES and TDAE oils. Processing oils are also known to include, inter alia, plant-based oils, such as sunflower oil, rapeseed oil and vegetable oil. Some of the rubber compositions disclosed herein may include an elastomer, such as a styrene-butadiene rubber, that has been extended with one or more such processing oils but such oil is limited in the rubber composition of particular embodiments as being no more than 40 phr of the total elastomer content of the rubber composition.

Vulcanization system: The vulcanization system is preferably, for particular embodiments, one based on sulfur and on an accelerator but other vulcanization agents known to one skilled in the art may be useful as well, for example, peroxide and ionic crosslinking agents. Vulcanization agents as used herein are those materials that cause the cross-linkage of the rubber and therefore may be added only to the productive mix so that premature curing does not occur, such agents including, for example, elemental sulfur, sulfur donating agents, and peroxides. Use may be made of any compound capable of acting as an accelerator of the vulcanization of elastomers in the presence of sulfur, in particular those chosen from the group consisting of 2-mercaptobenzothiazyl disulfide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-tert-butyl-2-benzothiazolesulphenamide (abbreviated to “TBBS”), N-tert-butyl-2-benzothiazole-sulphenimide (abbreviated to “TBSI”) and the mixtures of these compounds. Preferably, a primary accelerator of the sulfenamide type is used.

The rubber composition may also include vulcanization retarders, a vulcanization system based, for example, on sulfur or on a peroxide, vulcanization accelerators, vulcanization activators, and so forth. The vulcanization system may further include various known secondary accelerators or vulcanization activators, such as zinc oxide, stearic acid and guanidine derivatives (in particular diphenylguanidine, or “DPG”).

Other components: The rubber compositions disclosed herein may further include, in addition to the compounds already described, all or part of the components often used in diene rubber compositions intended for the manufacture of tires, such as additional protective agents of the type that include antioxidants and/or antiozonants, such as 6PPD, 77PD, TMQ, hindered phenol, and wax. There may also be added, if desired, one or more conventional non-reinforcing fillers such as clays, bentonite, talc, chalk kaolin, aluminosilicate, fiber, or coal.

The rubber compositions that are embodiments of the present invention may be produced in suitable mixers in a manner known to those having ordinary skill in the art. Typically, the mixing may occur using two successive preparation phases, a first phase of thermo-mechanical working at high temperature followed by a second phase of mechanical working at a lower temperature.

The first phase, sometimes referred to as a “non-productive” phase, includes thoroughly mixing, typically by kneading, the various ingredients of the composition but excluding some of the vulcanization system such as the vulcanization agents, the accelerators, the retarders, and the linking agents of the antiozonants. This first phase is carried out in a suitable kneading device, such as an internal mixer of the Banbury type, until under the action of the mechanical working and the high shearing imposed on the mixture, a maximum temperature of generally between 120° C. and 190° C. is reached, indicating that the components are well dispersed.

After cooling the mixture, a second phase of mechanical working is implemented at a lower temperature. Sometimes referred to a “productive” phase, this finishing phase consists of incorporating some of the aforementioned vulcanization system that were not added in the “non-productive” phase, including the vulcanization agents, the accelerators, the retarders, and the antiozonant linking agents into the rubber composition using a suitable device, such as an open mill. It is performed for an appropriate time (typically, for example, between 1 and 30 minutes or between 2 and 10 minutes), and at a sufficiently low temperature, i.e., lower than the vulcanization temperature of the mixture, so as to protect against premature vulcanization.

The rubber composition can be formed into useful articles, including tire components. Tire treads, for example, may be formed as tread bands and then later made a part of a tire or they be formed directly onto a tire carcass by, for example, extrusion and then cured in a mold. Other components such as those located in the bead area of the tire or in the sidewall may be formed and assembled into a green tire and then cured with the curing of the tire.

The characterization of the innovative antiozonant molecules and linking agents and the properties of the rubber compositions disclosed in the examples were evaluated as described below.

NMR analysis: Structural analyses as well as molar purity determination of the sPPD-OH and sPAQI are conducted with NMR analysis. Spectra are acquired on Avance 3, 400 MHz, BRUKER spectrometer fitted with a “large band” BBFO-zgrad 5 mm probe. Quantitative NMR ¹H experience uses a 30° simple impulse and a repeating period of 3 seconds between each 64 acquisitions. Samples are solubilized in deuterated dimethylsulfoxide (DMSO). This solvent is also used for the lock signal. Calibration is done on deuterated DMSO protons signal at 2.44 ppm with a TMS reference at 0 ppm. NMR ¹H experience is coupled with 2D HSQC ¹H/¹³C and HMBC ¹H/¹³C experiences in order to determine the structure of molecules given in the attribution tables. Molar quantification of purity is given from NMR 1D ¹H spectrum.

Rheometer: the curing and cured characteristics of the rubber compositions are conducted by using MDR (moving die rheometer) according to ASTM D2084. The test is conducted at 150° C.

Static ozone cracking test: the static ozone surface cracking is evaluated using a test closely related to the ASTM 1149-99 Standard Test Method for rubber deterioration titled Surface Ozone Cracking in a Chamber. The testing utilized in the examples that follow differs in the construction of the sample holder, which was a rod rather than a wooden block holder as required under the ASTM test method. Rectangular samples are made by sheeting the green rubber, molding into a specified mold, curing at a specified cure temp and time, cooling down, cutting with a die, then folding in half and stapling such that the curvature of the loop has a maximum local strain of 18%. These samples are hung on a rod for 2 days under ambient conditions before being placed in an ozone chamber. The ozone chamber conditions are set at 50 parts per hundred million ozone (pphm) and a temperature of 40° C. for a specified duration. The samples are periodically evaluated for cracks. The surface cracks of the samples are then evaluated using the Rubber Deterioration Test Grades that consists of three numbers. The first number indicates the number of cracks in the sample, the second rates the width of the cracks and the third number is the depth of the crack. The higher the numbers, the more severe the ozone cracks. Zero indicates that no cracks are observed. The ozone cracking index is the product of the three numbers determined by the Rubber Deterioration Test Grades. A normalized index is used by normalizing the index of a “comparative formulation” to that of the “witness formulation”.

Dynamic ozone cracking test: the sample preparation and ozone cracking indexing are identical to those of static ozone cracking test described above, except that the samples are subjected to a cyclic strain up to 25% at 30 RPM for up to 2 days in the ozone chamber.

Antiozonant migration and antiozonation longevity tests: the migration of an antiozonant in a rubber to its surrounding rubbers is conducted in a “composite” ozone sample, and the longevity of the antiozonation is assessed by grading the surface ozone cracks on the “composite” ozone sample after exposure to ozone environment.

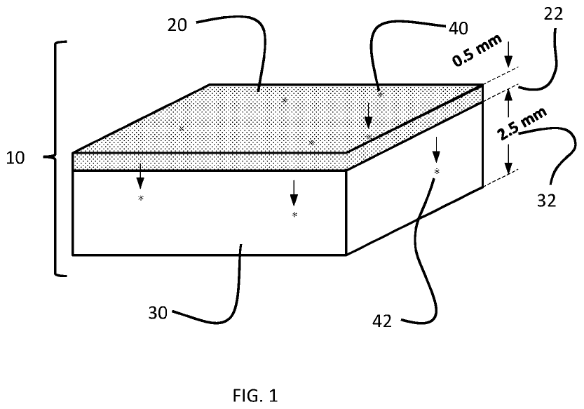

First, a “base formulation” 30 without any antiozonant and a “comparative formulation” 20 with a specific antiozonant 40, 42 at a specified loading are made separately according to the procedures described above and shown in FIG. 1. Then, a “composite” ozone sample 10, as shown in FIG. 1, is prepared by sheeting the “base formulation” 30 (which has no antiozonant) into a 2.5 mm thick skim 32 and a “comparative formulation” 20 (which contains an antiozonant) into a 0.5 mm thick skim 22, stacking the “comparative formulation” skim on top of the “base formulation” skim to make a “composite”. The “composite” sample is then cured at specified conditions, and purposely left at ambient condition for 14 days. The sample is then stapled/looped on a rod, making sure that the “comparative formulation” is facing outside on the loop. Then the sample is exposed to ozone in the ozone chamber for a specified duration. Then, the surface ozone cracks of the “comparative formulation” is graded, and a normalized cracking index is calculated exactly the same way as described in the “static ozone cracking test”.

Notice that as soon as the “comparative formulation” containing an antiozonant 40 and the “base formulation” without any antiozonant are in intimate contact, some of the antiozonant molecules 42 in the “comparative formulation” skim 20 will start migrating to the “base formulation” skim 30 until a concentration equilibrium is reached, which theoretically should take infinite time. The migration rate in this process is dependent on various factors such as the molecular size of the antiozonant, the solubility and affinity of the antiozonant in the formulation matrix, as well as the environmental conditions. A faster migration of an antiozonant from a “comparative formulation” skim will result in a lower residual concentration of the antiozonant in this “comparative formulation”, and thus a severer ozone cracking after exposed to ozone environment. Therefore, a smaller ozone cracking index indicates a slower migration and a longer lasting protection agent.

The invention is further illustrated by the following examples, which are to be regarded only as illustrations and not delimitative of the invention in any way.

### EXAMPLES

### Example 1

This example illustrates the synthesis and characterization of 4-{[4-(dimethylamino)phenyl]imino}cyclohexa-2,5-dien-1-one, denoted as dPAQI, a model compound of structure (II), with the synthesis route showing in the following equation, and NMR characterization showing in Table 1.

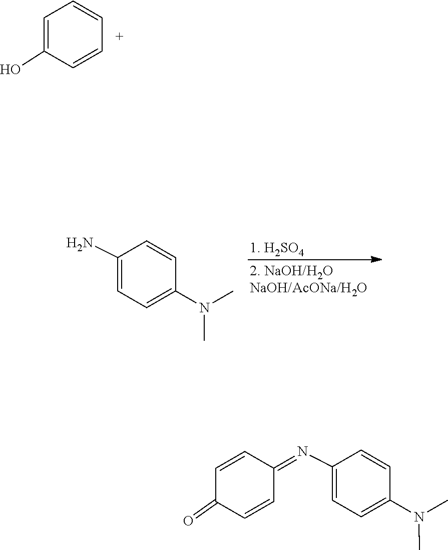

A solution of phenol (10.0 g, 0.106 mol), sodium hydroxide (5.53 g, 0.138 mol) and sodium acetate (6.97 g, 0.085 mol) in water (400 mL) was stirred mechanically at −5° C. Two dropping funnels were put in place, one containing an aqueous solution of NaOCl (active chloride 4%, 201 mL, 0.138 mol) the other a solution of N,N-dimethyl-p-phenylenediamine sulfate (17.43 g, 0.074 mol) in water (200 mL). The two solutions were then added in the phenol solution simultaneously in the course of one hour. The temperature was kept at −5° C. during the addition. Stirring was continued under −5° C. for one hour and the blue precipitate was filtrated, washed several times by water (600 mL) and dried under air for 10-15h.

A dark blue solid (14.35 g, 0.063 mol) was obtained with a yield of 85%. The NMR ¹H purity of the crude product was 95% mol. The crude solid was crystallized from ethyl acetate (from 80° C. to −18° C.) to give dark blue crystals (12.98 g, 0.057 mol) with a yield of 77%. The melting point is 153° C. The NMR ¹H purity was 97% mol.

TABLE 1
Characterization of dPAQI by NMR ¹H and ¹³C in DMSO.

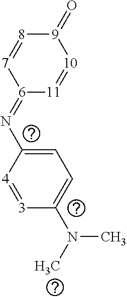

| N^{o} | δ ¹H (ppm) | δ ¹³C (ppm) |
|---|---|---|
| 1 | 2.97 | 39.6 |
| 2 | / | 150.1 |
| 3 | 6.77 | 112 |
| 4 | 7.01 | 125.9 |
| 5 | / | 138.4 |
| 6 | / | 152.1 |
| 7/11 | 7.28 | 128.3/141.9 |
| 8/10 | 6.52 | 130/131.1 |
| 9 | / | 186.6 |

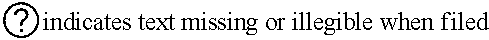

Significant to note that the ring of the dimethyl-p-phenylamine-quinoneimine to which the oxygen is double bonded is no longer an aromatic ring. It is anticipated that the product of ozonation of this molecule should be different than 6PPD-quinone and therefore may have a different toxicity effect to the soho salmon mentioned above.

### Example 2

This example shows the synthesis and characterization of 4-{[4-(dimethylamino)phenyl]amino}phenol, denoted as dPPD-OH, a model compound of structure (I), with the synthesis route showing in the following equation, and NMR characterization showing in Table 2.

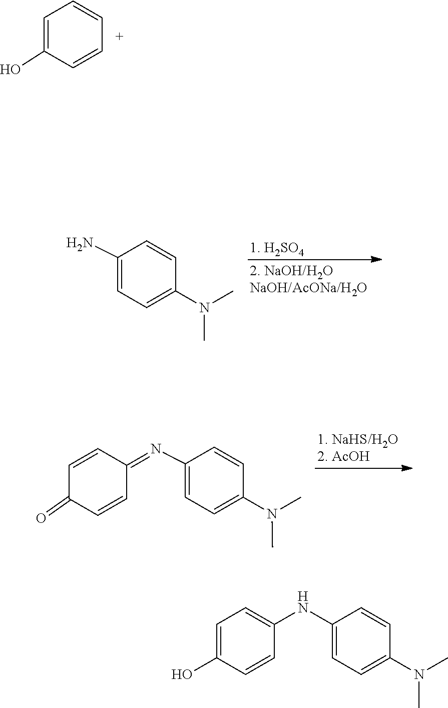

A solution of phenol (4.44 g, 47.2 mmol), sodium hydroxide (2.45 g, 61.4 mmol) and sodium acetate (3.10 g, 37.8 mmol) in water (200 mL) was stirred mechanically at −5° C. Two dropping funnels were put in place, one containing an aqueous solution of NaOCl (active chloride 4%, 101 mL, 0.69 mol) the other a solution of N,N-dimethyl-p-phenylenediamine sulfate (4.50 g, 23.1 mmol) and sulfuric acid (2.3 mL, 43.1 mmol) in water (100 mL). The two solutions were then added simultaneously in the course of one hour. The temperature is kept under 0° C. during the addition. Stirring was continued under 0° C. for 2 hours and the blue precipitate was filtrated, washed for several times by water (300 mL). A dark blue solid (5.5g) was obtained. The NMR ¹H purity is 59% mol of dPAQI and 12% mol of dPPD-OH.

The crude solid was used directly for the next step. A solution of sodium hydroxide (6.0 g, 0.15 mol) and the crude product (5.5 g) was stirred in water (250 mL) for 1 hour at room temperature. Sodium hydrosulfide (25 g) was added and the dark suspension was stirred for 30 minutes. The solid was filtrated and washed by water (three times with 25 mL each) and dried under vacuum at 50° C. A grey solid (1.80 g, 7.85 mmol) was obtained with a yield of 34%. The melting point is 155-158° C. The NMR ¹H purity was 94% mol.

TABLE 2
Characterization of dPPD-OH by NMR ¹H and ¹³C in DMSO.

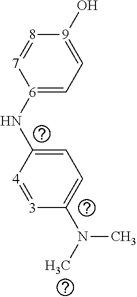

| N^{o} | δ ¹H (ppm) | δ ¹³C (ppm) |
|---|---|---|
| 1 | 2.72 | 40.9 |
| 2 | / | 144.4 |
| 3 | 6.6 | 114 |
| 4 | 6.78 | 117.9 |
| 5 | / | 135.3 |
| 6 | / | 136.8 |
| 7 | 6.71 | 117.6 |
| 8 | 6.55 | 115.3 |
| 9 | / | 150.1 |

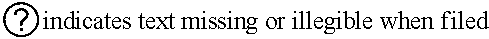

### Example 3

This example demonstrates the antiozone performances of the new antiozonation systems in this invention at static and dynamic conditions. Table 3 showed the static and dynamic ozone cracking indices of formulations with 1.2 phr 6PPD with and without 0.06 phr HMT, dPPD-OH with 0.06 phr HMT, and dPAQI with 0.06 phr HMT, respectively, in which the ozone rubber samples were cured for 15 minutes at 150° C. before the cracking test. Notice that the higher the cracking index, the more sever the cracking, and the lower the anti-ozonation performance. As can be seen, compared to the widely used antiozonant 6PPD in W1-1 as well as 6PPD with HMT in W1-2, the dPPD-OH with HMT in F1-1 and dPAQI with HMT in F1-2 indicated equivalent initial antiozonation performances at both static and dynamic conditions, as represented by their corresponding ozone cracking indices.

TABLE 3
Static and dynamic ozone cracking indices in non-oil formulations

| | Example | | | |
|---|---|---|---|---|
| | W1-1 | W1-2 | F1-1 | F1-2 |
| Ingredients | | | | |
| Natural rubber | 100 | 100 | 100 | 100 |
| Carbon black N347 | 50 | 50 | 50 | 50 |
| SAD | 2 | 2 | 2 | 2 |
| ZnO | 4 | 4 | 4 | 4 |
| S | 3 | 3 | 3 | 3 |
| CBS | 1 | 1 | 1 | 1 |
| 6PPD | 1.2 | 1.2 | | |
| dPPDOH | | | 1.2 | |
| dPAQI | | | | 1.2 |
| HMT | | 0.06 | 0.06 | 0.06 |
| Properties | | | | |
| MDR max torque, dNm | 24.7 | 25.6 | 27.2 | 26.9 |
| MDR min torque, dNm | 2.2 | 2.3 | 2.5 | 2.4 |
| Static ozone cracking index | 100 | 100 | 100 | 100 |
| Dynamic ozone cracking index | 100 | 100 | 100 | 100 |

### Example 4

This example demonstrates the superior antiozonation longevity of this invention using the aforementioned composite migration test. Table 4 showed the formula of a “base formulation” without any antiozonant or linking agent. Table 5 showed the formulas and the test results of the “comparative formulations”, where the composite ozone samples were cured for 20 minutes at 150° C. As can be seen, addition of HMT in the widely used 6PPD did not significantly change 6PPD's composite ozone cracking index, 94 and 100 for W2-2 and W2-1, respectively. On the other hand, the cracking indices, 8 and 10 for dPPH-OH with HMT in F2-1 and dPAQI with HMT in F2-2, respectively, of this invention were significantly lower than 100 for the widely used 6PPD formulation. These relative values of composite ozone cracking indices indicated that the antiozonation systems from this invention will provide longer ozone protection of the rubbers than the widely used 6PPD.

TABLE 4
Oil-containing “base formulation”

| Base formulation, phr | W2-0 |
|---|---|
| Natural rubber | 100 |
| Carbon black N347 | 55 |
| Naphthenic oil | 5 |
| Stearic acid | 1 |
| Zinc oxide | 3 |
| Sulfur | 3 |
| Accelerator CBS | 1 |

TABLE 5
Comparative formulations and test properties

| | Example | | | |
|---|---|---|---|---|
| | W2-1 | W2-2 | F2-1 | F2-2 |
| Ingredients, phr | | | | |
| Natural rubber | 100 | 100 | 100 | 100 |
| Carbon black N347 | 55 | 55 | 55 | 55 |
| Naphthenic oil | 5 | 5 | 5 | 5 |
| Stearic acid | 1 | 1 | 1 | 1 |
| Zinc oxide | 3 | 3 | 3 | 3 |
| Sulfur | 3 | 3 | 3 | 3 |
| Accelerator CBS | 1 | 1 | 1 | 1 |
| 6PPD | 3 | 3 | | 3 |
| dPPDOH | | | 3 | |
| dPAQI | | | | 3 |
| HMT | | 0.15 | 0.15 | 0.15 |
| Properties | | | | |
| MDR max torque, dNm | 23.2 | 24.9 | 28.0 | 28.4 |
| MDR min torque, dNm | 2.5 | 2.6 | 2.9 | 2.8 |
| Composite static ozone index | 100 | 94 | 8 | 10 |

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.” The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A rubber composition comprising:
a diene elastomer;
a reinforcing filler;
a vulcanization system; and
an antidegradant system that is comprised of an antiozonant and a linking agent,
wherein the antiozonant is having the following formula: 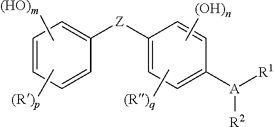
wherein m is 1 or 2;
wherein n is 0, 1, or 2;
wherein p is 0, 1, 2, 3, or 4;
wherein q is 0, 1, 2, 3, or 4;
wherein the summation of m and p is less than 6;
wherein the summation of n and q is less than 5;
wherein A is selected from nitrogen and sulfur;
wherein Z is selected from carbon, nitrogen, and sulfur;
wherein each of R′, R″, R¹, and R² can be the same or different, and each is selected from hydrogen, an alkyl moiety, a cycloalkyl moiety, an aryl moiety, an amine moiety, an amide moiety, an alcohol moiety, an aldehyde moiety, a ketone moiety, a carboxylic acid moiety, an ether moiety, an ester moiety, and a thiol moiety, or combinations thereof,
wherein the linking agent is selected from a methylene donor and an epoxide.

2. The rubber composition according to claim 1, wherein the linking agent is selected from hexamethylenetetramine and hexamethoxymethylmelamine.

3. The rubber composition according to claim 1, wherein the linking agent is selected from the following structures:

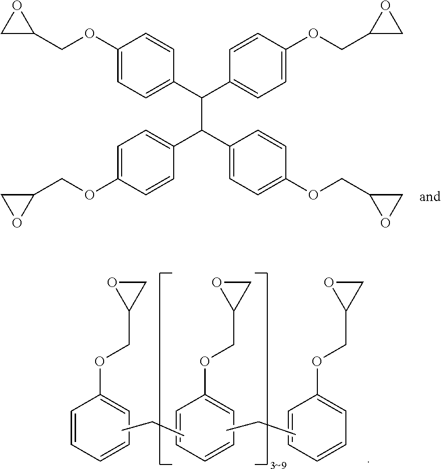

4. The rubber composition according to claim 1, wherein A is nitrogen.

5. The rubber composition according to claim 1, wherein Z is nitrogen.

6. The rubber composition according to any one of the above claims, wherein m is 1, n is 0.

7. The rubber composition according to any one of claims 1-6, wherein p is 0.1 or 2, q is 0.

8. The rubber composition according to any one of claims 1-6, R¹ is a C1-C18 alkyl moiety, R² is selected from hydrogen and a C1-C18 alkyl moiety.

9. The rubber composition according to any one of claims 1-6, wherein the antiozonant is comprised of 4-{[4-(dimethylamino)phenyl]amino}phenol and 4-({4-[(4-methylpentan-2-yl)amino]phenyl}amino) phenol.

10. The rubber composition according to any one of claims 1-6, wherein the amount of the antiozonant in the antiozonation system is between 0.2 to 15 phr.

11. The rubber composition according to any one of claims 1-6, wherein the amount of the linking agent in the antiozonation system is between 0.05 to 10 phr.

12. The rubber composition according to any one of claims 1-6, wherein the diene elastomer is a highly unsaturated diene elastomer selected from the group consisting of natural rubber, isoprene rubber, styrene-butadiene, polybutadiene, and any combinations thereof.

13. The rubber composition according to any one of claims 1-6, wherein the reinforcing filler is selected from the group consisting of carbon blacks, silicas, graphene, graphite, and combination thereof.

14. The rubber composition of any one of claims 1-6 further comprising an antioxidant and or antiozonant chosen from the group consisting of 6PPD, 77PD, TMQ, hindered phenol, wax or combinations thereof.

15. The rubber composition of any one of claims 1-6 comprising a plasticizer chosen from the group consisting of oils, resins, and combinations thereof.
